(19) United States
(12) Patent Application Publication
(10) Pub. No.: US 2017/0244482 A1
(43) Pub. Date: Aug. 24, 2017

(54) LIGHT-BASED COMMUNICATION PROCESSING

(71) Applicant: QUALCOMM Incorporated, San Diego, CA (US)

(72) Inventors: Michael DIMARE, Morristown, NJ (US); Aleksandar JOVICIC, Jersey City, NJ (US)

(21) Appl. No.: 15/052,686

(22) Filed: Feb. 24, 2016

(51) Int. Cl. H04B 10/116

(52) U.S. Cl. CPC H04B 10/116

(57) ABSTRACT

Disclosed are methods, devices, systems, media, and other implementations that include a method to process a light-based communication, including providing a light-capture device with one or more partial-image-blurring features, and capturing at least part of at least one image of a scene, that includes at least one light source emitting the light-based communication, with the light-capture device including the one or more partial-image-blurring features. The partial-image-blurring features are configured to cause a blurring of respective portions of the part of the captured image affected by the partial-image-blurring features. The method also includes decoding data encoded in the light-based communication based on the respective blurred portions, and processing the at least part of the at least one image including the blurred respective portions affected by the one or more partial-image-blurring features to generate a modified image portion (e.g., relatively less blurry, etc.) for the at least part of the at least one image.

### BACKGROUND

Light-based communication messaging, such as visible light communication (VLC), involves the transmission of information through modulation of the light intensity of a light source (e.g., the modulation of the light intensity of one or more light emitting diodes (LEDs)). Generally, visible light communication is achieved by transmitting, from a light source such as an LED or laser diode (LD), a modulated visible light signal, and receiving and processing the modulated visible light signal at a receiver (e.g., a mobile device) that includes a photo detector (PD) or array of PDs (e.g., a complementary metal-oxide-semiconductor (CMOS) image sensor (such as a camera)).

Light-based communication is limited by the number of pixels a light sensor uses to detect a transmitting light source. Thus, if a mobile device used to capture an image of the light source is situated too far from the light source, only a limited number of pixels of the mobile device's light-capture device (e.g., a camera) will correspond to the light source. Therefore, when the light source is emitting a modulated light signal, an insufficient number of time samples of the modulated light signal might be captured by the light-capture device.

### SUMMARY

In some variations, a method to process a light-based communication is provided. The method includes providing a light-capture device with one or more partial-image-blurring features, and capturing at least part of at least one image of a scene, the scene including at least one light source emitting the light-based communication, with the light-capture device including the one or more partial-image-blurring features. The one or more partial-image-blurring features are configured to cause a blurring of respective portions of the captured at least part of the at least one image that are affected by the one or more partial-image-blurring features. The method also includes decoding data encoded in the light-based communication based on the respective blurred portions of the captured at least part of the at least one image, and processing the at least part of the at least one image including the blurred respective portions of the captured at least part of the at least one image that are affected by the one or more partial-image-blurring features to generate a modified image portion for the at least part of the at least one image. By way of example, in certain implementations such a modified image portion may be or may appear to be when presented to the user, less blurry, clearer, sharper, or perhaps in some similar way substantially un-blurred, at least when compared to a respective blurred portion.

In some variations, a mobile device is provided that includes a light-capture device, including one or more partial-image-blurring features, to capture at least part of at least one image of a scene, the scene including at least one light source emitting a light-based communication, with the one or more partial-image-blurring features are configured to cause a blurring of respective portions of the captured at least part of the at least one image that are affected by the one or more partial-image-blurring features. The mobile device further includes memory configured to store the captured at least part of the at least one image, and one or more processors coupled to the memory and the light-capture device, and configured to decode data encoded in the light-based communication based on the respective blurred portions of the captured at least part of the at least one image, and process the at least part of the at least one image including the blurred respective portions of the captured at least part of the at least one image that are affected by the one or more partial-image-blurring features to generate a modified image portion for the at least part of the at least one image.

In some variations, an apparatus is provided that includes means for capturing at least part of at least one image of a scene, the scene including at least one light source emitting a light-based communication, with a light-capture device including one or more partial-image-blurring features. The one or more partial-image-blurring features are configured to cause a blurring of respective portions of the captured at least part of the at least one image that are affected by the one or more partial-image-blurring features. The apparatus further includes means for decoding data encoded in the light-based communication based on the respective blurred portions of the captured at least part of the at least one image, and means for processing the at least part of the at least one image including the blurred respective portions of the captured at least part of the at least one image that are affected by the one or more partial-image-blurring features to generate a modified image portion for the at least part of the at least one image.

In some variations, a non-transitory computer readable media is provided that is programmed with instructions, executable on a processor, to capture at least part of at least one image of a scene, the scene including at least one light source emitting a light-based communication, with a light-capture device including one or more partial-image-blurring features. The one or more partial-image-blurring features are configured to cause a blurring of respective portions of the captured at least part of the at least one image that are affected by the one or more partial-image-blurring features. The instructions are further configured to decode data encoded in the light-based communication based on the respective blurred portions of the captured at least part of the at least one image, and process the at least part of the at least one image including the blurred respective portions of the captured at least part of the at least one image that are affected by the one or more partial-image-blurring features to generate a modified image portion for the at least part of the at least one image.

Other and further objects, features, aspects, and advantages of the present disclosure will become better understood with the following detailed description of the accompanying drawings.

### BRIEF DESCRIPTION OF THE DRAWINGS

FIG. 1 is a schematic diagram of a light-based communication system, in accordance with certain example implementations.

FIG. 2 is a diagram of another light-based communication system with multiple light fixtures, in accordance with certain example implementations.

FIG. 3 is a diagram illustrating captured images, over three separate frames, of a scene that includes a light source emitting a coded light-based message, in accordance with certain example implementations.

FIG. 4 is a block diagram of a device configured to capture images of a light source transmitting light-based communications, and to decode messages encoded in the light-based communications, in accordance with certain example implementations.

FIG. 5 is a diagram of a system to determine position of a device, in accordance with certain example implementations.

FIGS. 6-7 are illustrations of images, captured by a sensor array, that include regions of interest corresponding to a light-based communication transmitted by a light source, in accordance with certain example implementations.

FIG. 8 is a flowchart of a procedure to decode light-based communications, in accordance with certain example implementations.

FIGS. 9A-C are images of a scene including multiple light sources emitting light-based communications, in accordance with certain example implementations.

FIG. 10 is a schematic diagram of a computing system, in accordance with certain example implementations.

Like reference symbols in the various drawings indicate like elements.

### DETAILED DESCRIPTION

Described herein are methods, systems, devices, apparatus, computer-/processor-readable media, and other implementations for reception, decoding, and processing of light-based communication data, including a method to decode a light-based communication (also referred to as light-based encoded communication, or optical communication) that includes providing a light-capture device with one or more partial-image-blurring features (e.g., one or more stripes placed on a lens of a camera, one or more scratches formed on the lens of the camera), and capturing at least part of at least one image of a scene that includes at least one light source emitting the light-based communication using the light-capture device including the one or more partial-image-blurring features, with the one or more partial-image-blurring features being configured to cause a blurring of respective portions of the captured at least part of the at least one image that are affected by the one or more partial-image-blurring features (e.g., only certain portions, associated with the respective partial-image-blurring features, may be blurred with the remainder of the image being affected to a lesser extent, or not affected at all, by the blurring effects of those features). The method also includes decoding data encoded in the light-based communication based on the respective blurred portions of the captured at least part of the at least one image, and processing the at least part of the at least one image including the blurred respective portions of the captured at least part of the at least one image that are affected by the one or more partial-image-blurring features to generate a modified image portion for the at least part of the at least one image. By way of example, in certain implementations such a modified image portion may be or may appear to be when presented to the user, less blurry, clearer, sharper, or perhaps in some similar way substantially un-blurred, at least when compared to a respective blurred portion.

In some embodiments, the light-based communication may include a visual light communication (VLC) signal, and decoding the encoded data may include identifying from the captured at least part of the at least one image a time-domain signal representative of one or more symbols comprising a VLC codeword encoded in the VLC signal, and determining, at least in part, the VLC codeword from the time-domain signal identified from the captured at least part of the at least one image. In some embodiments, the light-capture device may include a digital camera with a gradual-exposure mechanism (e.g., a CMOS camera including a rolling shutter). Use of partial-image-blurring features can simplify the procedure to find and decode light-based signals because the location(s) in an image where decoding processing is to be performed would be known, and because, in some situations, the signal would be spread across enough sensor rows to decode it completely in a single pass. Additionally, the partial-image-blurring features (e.g., scratches or coupled/coated structures or materials) can be digitally removed to present an undamaged view of the scene. For example, if a 1024-row sensor had ten (10) vertical scratches of two (2) pixels each, it would lose approximately 2 percent of its resolution, and a high-quality reconstruction of the affected image could be obtained.

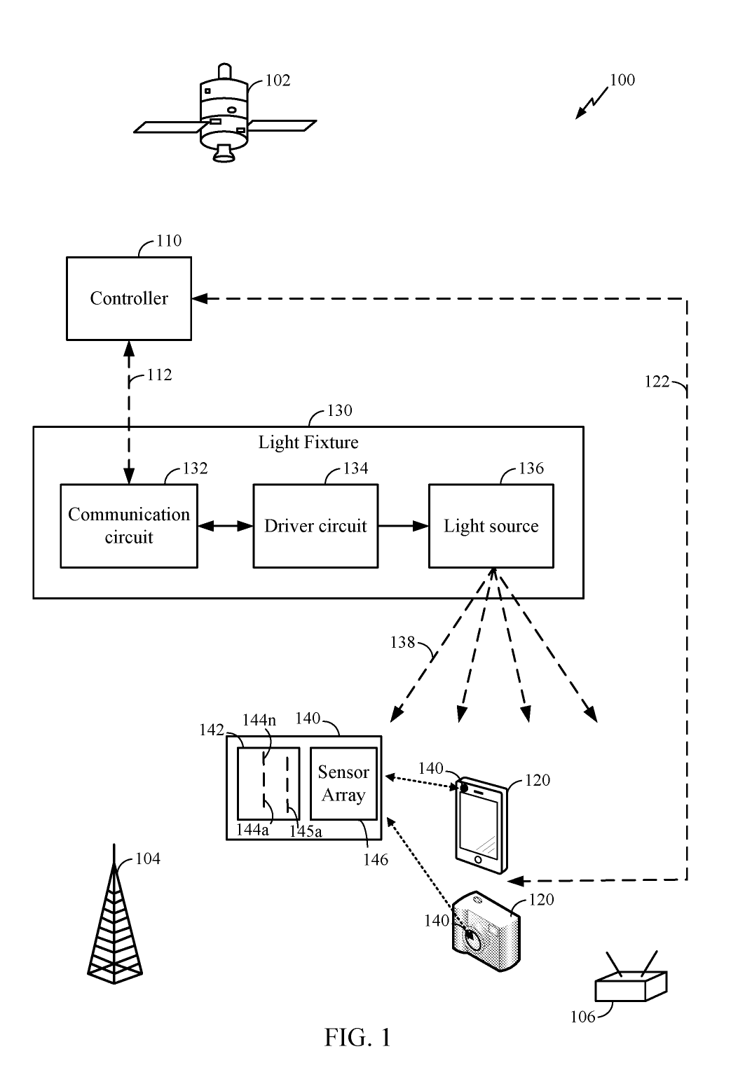

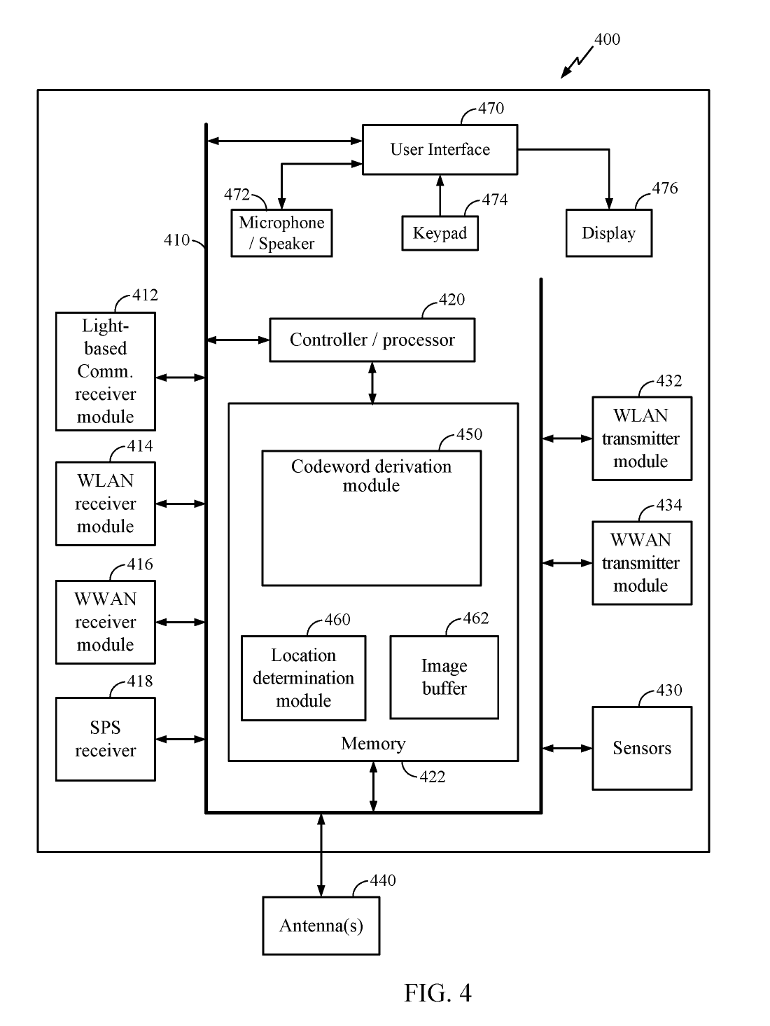

With reference to FIG. 1, a schematic diagram of an example light-based communication system 100 that can be used to transmit light-based communications (such as VLC signals) is shown. The light-based communication system 100 includes a controller 110 configured to control the operation/functionality of a light fixture 130. The system 100 further includes a device 120 configured to receive and capture light emissions from a light source of the light fixture 130 (e.g., using a light sensor, also referred to as a light-based communication receiver module, such as the light-based communication receiver module 412 depicted in FIG. 4), and to decode data encoded in the emitted light from the light fixture 130. The device 120 may be a wireless mobile device (such as a cellular mobile phone) that is equipped with a camera, a dedicated digital camera device (e.g., such as portable digital camera, or a digital camera that is mounted in a car, a computer, or some other structure), etc. Light emitted by a light source 136 of the light fixture 130 may be controllably modulated to include sequences of pulses (of fixed or variable durations) corresponding to codewords to be encoded into the emitted light. In some embodiments, the light-based communication system 100 may include any number of controllers such as the controller 110, devices such as the device 120, and/or light fixtures such as the light fixture 130. As will become apparent below, in some embodiments, visible pulses for codeword frames emitted by the light fixture 130 are captured by a light-capture unit 140 (which includes at least one lens and a sensor array) of the device 120, and are decoded. The light-capture device 140 of the device 120 may be configured so that images captured by the light-capture device are defocused (e.g., substantially the entire images are defocused), or such that selected portions of the images captured by the light-capture device are blurred. By blurring or defocusing images (partially or fully) received from one or more light sources (emitting light modulated data), the received light is spread into corresponding one or more blurred spots, resulting in an increase of the pixel coverage for the light received from the sources emitting the modulated light. Thus, a larger part of a scanning frame for the light-capture device would be used to capture the modulated light from the light sources, and therefore, more of the message encoded in the modulated light would be captured by the light-capture device for further processing. The intentional blurring or defocusing can be done intermittently, e.g., while a gradual image scan is being performed, and focused images can be used to pinpoint the position(s) of light source(s).

More particularly, as schematically depicted in FIG. 1, the light-capture device 140 (which may be a fixed-focus or a variable-focus device) may include at least one lens 142 that includes one or more partial-image blurring features 144a-n configured to cause a blurring of respective portions of the captured at least part of the at least one image that are affected by the one or more partial-image-blurring features. As shown, in some embodiments, the one or more partial-image blurring features may include multiple stripes defining an axis oriented substantially orthogonal to a scanning direction at which images are captured by the light-capture device. For example, the scanning direction at which images are captured may be done along rows of the image (e.g., left to right in FIG. 1), and thus, the stripes may be arranged so that they define an axis perpendicular to the rows of the image (or rows the sensor array capturing the images). The partial-image blurring features may be arranged so as to define multiple axes. For example, the partial-image blurring features 144a-n may define a first line, and partial-image-blurring features 145a-n may define another line (that is substantially parallel to the line defined by the features 144a-n) but positioned at another location on the at least one lens 142. In some embodiments, the one or more partial-image-blurring features may be formed by coupling stripe-shaped structures onto the lens (e.g., coating/applying a translucent material onto the lens). Alternatively and/or additionally, providing the lens with the one or more partial-image-blurring features may include forming stripe-shaped scratches in the lens. Although FIG. 1 shows a single lens, more than one lens may be used to constitute a lens assembly through which light is directed to the light-capture device sensor array. In such an assembly, one of the lenses, e.g., the lens including the one or more partial-image blurring features, may be a moveable/displaceable lens (e.g., can be moved relative to the other lens), to thus cause re-positioning of the one or more partial-image blurring features relative to the other lens and/or the sensor array. For example, the moveable lens may be displaced so as to align the one or more partial-image blurring features included with the lens to more closely overlap with one or more of the light sources emitting modulated light to thus cause a more pronounced blurring of the light emitted from those light sources. A moveable lens may be displaced using tracks (into which one or more edges of the lens may be inserted), or through any other type of guiding mechanism. Alternatively and/or additionally, in some embodiments, the lens may be mechanically coupled to a motor to cause movement of the lens according to control signals provided by the light-capture device (e.g., in response to input from the user wishing to move the lens to more properly align with distant light source emitting modulate light, or automatically in response to detection/identification of light sources appearing in the captured image).

As depicted in FIG. 1, light passing through (and optically processed by) the lens 142 including the one or more partial-image-blurring features (that are configured to cause a blurring of respective portions of the captured at least part of the image affected by the one or more partial-image-blurring features) is detected by a sensor array 146 that converts the optical signal into digital signal constituting the captured image. The detector 146 may include one or more of a complementary metal oxide semiconductor (CMOS) detector device, a charged coupled device (CCD), or some other device configured to convert an optical signal into digital data.

The resultant digital image(s) may then be processed by a processor (e.g., one forming part of the light-capture device 140 of the device 120, or one that is part of the mobile device and is electrically coupled to the detector 146 of the light-capture device 140) to, as will more particularly be described below, detect/identify the light sources emitting the modulated light, decode the coded data included in the modulated light emitted from the light sources detected within the captured image(s), and/or perform other operations on the resultant image. For example, a ‘clean’ image data may be derived from the captured image to remove blurred artifacts appearing in the image by filtering (e.g., digital filtering implemented by software and/or hardware) the detected image(s). Such filtering operations may implement an inverse function of a known or approximated function representative of the blurring effect caused by the partial-image-blurring effect. Particularly, in circumstances where the characteristics of partial-image-blurring features can be determined precisely or approximately (e.g., because the dimensions and characteristics of the materials or scratches is known), a mathematical representation of the optical filtering effect these partial-image-blurring feature cause may be derived. Thus, an inverse filter (representative of the inverse mathematical representation of the mathematical representation of the filtering causes by the partial-image-blurring features) can also be derived. In such embodiments, the inverse filtering applied through operations performed by the processor used for processing the detected image(s) may yield a reconstructed/restored image in which the blurred portions (whose locations in the image(s) are known since the locations of partial-image-blurring features are known) are de-blurred (partially or substantially entirely). Other processes/techniques to de-blur the captured image(s) (or portions thereof) may be performed to process at least part of the at least one image of the scene (captured by the light-capture device) that includes the blurred respective portions for the captured at least part of the at least one image that are affected by the one or more partial-image blurring features to generate a modified image portion for the at least part of the at least one image.

In some embodiments, processing performed on the captured image (including processing performed on any blurred portions of the image) includes decoding data encoded in the light-based communication(s) emitted by the light source(s) based on the respective blurred portions of the captured at least part of the at least one image. In some embodiments, the light-based communication(s) may include a visual light communication (VLC) signal(s), and decoding the encoded data may include identifying from the captured at least part of the at least one image a time-domain signal representative of one or more symbols comprising a VLC codeword encoded in the VLC signal, and determining, at least in part, the VLC codeword from the time-domain signal identified from the captured at least part of the at least one image.

To improve the decoding process, the partial-image-blurring features placed on the lens may be aligned with the parts of the images corresponding to the light source(s) emitting the light-based communication (thus causing a larger portion of the parts of the image(s) corresponding to the modulated emitted light to become blurred, resulting in more scanned lines of the captured image to be occupied by data corresponding to the light-based communication emitted by the light sources). As noted, the alignment of the partial-image-blurring features with the light sources appearing in the captured images may be performed by displacing the lens including the partial-image-blurring features relative to the rest of the light-capture device (e.g., through a motor and tracks mechanism), by re-orienting the light-capture device so that the partial-image-blurring features more substantially cover/overlap the light sources appearing in captured images, etc. In some embodiments, decoding of the data encoded in the light-based communication may be performed with the partial-image-blurring features not being aligned with the parts in the captured images corresponding to the light sources. In those situations, the partial-image-blurring features will still cause some blurring of the parts of the image corresponding to the light source(s) emitting the encoded light-based communications. Particularly, in such situations, the sensor elements of the light-capture device that are aligned with the blurred portion of the lens assembly are effectively measuring the intensity of ambient light level. Due to the modulation in the light-based messaging, the light intensity varies over time, and therefore, in a gradual-exposure mechanism implementation (e.g., rolling shutter), each scanned sensor row represents a snapshot in time of the light intensity and it is the variation of intensity that is being decoded. The blurring thus helps to average the light intensity striking the sensor and consequently to facilitate better decoding.

As further shown in FIG. 1, the light fixture 130 includes, in some embodiments, a communication circuit 132 to communicate with, for example, the controller 110 (via a link or channel 112, which may be a WiFi link, a link established over a power line, a LAN-based link, etc.), a driver circuit 134, and/or a light source 136. The communication circuit 132 may include one or more transceivers, implemented according to any one or more of communication technologies and protocols, including IEEE 802.11 (WiFI) protocols, near field technologies (e.g., Bluetooth® wireless technology network, ZigBee, etc.), cellular WWAN technologies, etc., and may also be part of a network (a local area network (LAN), a wireless LAN (WLAN), a wide area network (WAN), a wireless WAN (WWAN), etc.) assigned with a unique network address (e.g., an IP address). The communication circuit 132 may be implemented to facilitate wired communication, and may thus be connected to the controller 110 via a physical communication link. The controller 110 may in turn be a network node in a communication network to enable network-wide communication to and from the light fixture 130. In some implementations, the controller may be realized as part of the communication circuit 132. In some embodiments, the controller may be configured to set/reset the codeword at each of the light fixtures. A light fixture may have a sequence of codewords, and the controller may be configured to provide a control signal to cause the light fixture to cycle through its list of codewords. Alternatively and/or additionally, in some embodiments, light fixtures may be addressable so that a controller (such as the controller 110 of FIG. 1) may access a particular light fixture to provide instructions, new code words, light intensity, frequency, and other parameters for any given fixture.

In some examples, the light source 136 may include one or more light emitting diodes (LEDs) and/or other light emitting elements. In some configurations, a single light source or a commonly controlled group of light emitting elements may be provided (e.g., a single light source, such as the light source 136 of FIG. 1, or a commonly controlled group of light emitting elements may be used for ambient illumination and light-based communication transmissions). In other configurations, the light source 136 may be replaced with multiple light sources or separately controlled groups of light emitting elements (e.g., a first light source may be used for ambient illumination, and a second light source may be used to implement coded light-based communication such as VLC signal transmissions).

The driver circuit 134 (e.g., an intelligent ballast) may be configured to drive the light source 136. For example, the driver circuit 134 may be configured to drive the light source 136 using a current signal and/or a voltage signal to cause the light source to emit light modulated to encode information representative of a codeword (or other data) that the light source 136 is to communicate. As such, the driver circuit may be configured to output electrical power according to a pattern that would cause the light source to controllably emit light modulated with a desired codeword (e.g., an identifier). In some implementations, some of the functionality of the driver circuit 134 may be implemented at the controller 110.

By way of example, the controller 110 may be implemented as a processor-based system (e.g., a desktop computer, server, portable computing device or wall-mounted control pad). Controlling signals to control the driver circuit 134 may be communicated, in some embodiments, from the device 120 to the controller 110 via, for example, a wireless communication link/channel 122, and the transmitted controlling signals may then be forwarded to the driver circuit 134 via the communication circuit 132 of the fixture 130. In some embodiments, the controller 110 may also be implemented as a switch, such as an ON/OFF/dimming switch. A user may control performance attributes/characteristics for the light fixture 130, e.g., an illumination factor specified as, for example, a percentage of dimness, via the controller 110, which illumination factor may be provided by the controller 110 to the light fixture 130. In some examples, the controller 110 may provide the illumination factor to the communication circuit 132 of the light fixture 130. By way of example, the illumination factor, or other controlling parameters for the performance behavior of the light fixture and/or communications parameters, timing, identification and/or behavior, may be provided to the communication circuit 132 over a power line network, a wireless local area network (WLAN; e.g., a Wi-Fi network), and/or a wireless wide area network (WWAN; e.g., a cellular network such as a Long Term Evolution (LTE) or LTE-Advanced (LTE-A) network, or via a wired network).

In some embodiments, the controller 110 may also provide the light fixture 130 with a codeword (e.g., an identifier) for repeated transmission using VLC. The controller 110 may also be configured to receive status information from the light fixture 130. The status information may include, for example, a light intensity of the light source 136, a thermal performance of the light source 136, and/or the codeword (or identifying information) assigned to the light fixture 130.

The device 120 may be implemented, for example, as a mobile phone, a tablet computer, a dedicated camera assembly, etc., and may be configured to communicate over different access networks, such as other WLANs and/or WWANs and/or personal area networks (PANs). The mobile device may communicate uni-directionally or bi-directionally with the controller 110. As noted, the device 120 may also communicate directly with the light fixture 130.

When the light fixture 130 is in an ON state, the light source 136 may provide ambient illumination 138 which may be captured by, for example, the light-capture device 140, e.g., a camera such as a CMOS camera, a charge-couple device (CCD)-type camera, etc., of the device 120. In some embodiments, the camera may be implemented with a rolling shutter mechanism configured to capture image data from a scene over some time period by scanning the scene vertically or horizontally so that different areas of the captured image correspond to different time instances. The light source 136 may also emit light-based communication transmissions that may be captured by the light-capture device 140. The illumination and/or light-based communication transmissions may be used by the device 120 for navigation and/or other purposes.

As also shown in FIG. 1, the light-based communication system 100 may be configured for communication with one or more different types of wireless communication systems or nodes. Such nodes, also referred to as wireless access points (or WAPs) may include LAN and/or WAN wireless transceivers, including, for example, WiFi base stations, femto cell transceivers, Bluetooth® wireless technology transceivers, cellular base stations, WiMax transceivers, etc. Thus, for example, one or more Local Area Network Wireless Access Points (LAN-WAPs), such as a LAN-WAP 106, may be used to provide wireless voice and/or data communication with the device 120 and/or the light fixture 130 (e.g., via the controller 110). The LAN-WAP 106 may also be utilized, in some embodiments, as an independent source (possibly together with other network nodes) of position data, e.g., through implementation of trilateration-based procedures based, for example, on time of arrival, round trip timing (RTT), received signal strength (RSSI) and other wireless signal-based location techniques. The LAN-WAP 106 can be part of a Wireless Local Area Network (WLAN), which may operate in buildings and perform communications over smaller geographic regions than a WWAN. Additionally, in some embodiments, the LAN-WAP 106 could also be pico or femto cell that is part of a WWAN network. In some embodiments, the LAN-WAP 106 may be part of, for example, WiFi networks (802.11x), cellular piconets and/or femtocells, Bluetooth® wireless technology Networks, etc. The LAN-WAPs 106 can also form part of an indoor positioning system.

The light-based communication system 100 may also be configured for communication with one or more Wide Area Network Wireless Access Points, such as a WAN-WAP 104 depicted in FIG. 1, which may be used for wireless voice and/or data communication, and may also serve as another source of independent information through which the device 120, for example, may determine its position/location. The WAN-WAP 104 may be part of a wide area wireless network (WWAN), which may include cellular base stations, and/or other wide area wireless systems, such as, for example, WiMAX (e.g., 802.16), femtocell transceivers, etc. A WWAN may include other known network components which are not shown in FIG. 1. Typically, the WAN-WAP 104 within the WWAN may operate from fixed positions, and provide network coverage over large metropolitan and/or regional areas.

Communication to and from the controller 110, the device 120, and/or the fixture 130 (to exchange data, facilitate position determination for the device 120, etc.) may thus be implemented, in some embodiments, using various wireless communication networks such as a wide area wireless network (WWAN), a wireless local area network (WLAN), a wireless personal area network (WPAN), and so on. The term “network” and “system” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), Long Term Evolution (LTE), and other wide area network standards. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. In some embodiments, 4G networks, Long Term Evolution (“LTE”) networks, Advanced LTE networks, Ultra Mobile Broadband (UMB) networks, and all other types of cellular communications networks may also be implemented and used with the systems, methods, and other implementations described herein. A WLAN may also be an IEEE 802.11x network, and a WPAN may be a Bluetooth® wireless technology network, an IEEE 802.15x or some other type of network. The techniques described herein may also be used for any combination of WWAN, WLAN and/or WPAN.

As further shown in FIG. 1, in some embodiments, the controller 110, the device 120, and/or the light fixture 130 may also be configured to at least receive information from a Satellite Positioning System (SPS) that includes a satellite 102, which may be used as an independent source of position information for the device 120 (and/or for the controller 110 or the fixture 130). The device 120, for example, may thus include one or more dedicated SPS receivers specifically designed to receive signals for deriving geo-location information from the SPS satellites. Transmitted satellite signals may include, for example, signals marked with a repeating pseudo-random noise (PN) code of a set number of chips and may be located on ground based control stations, user equipment and/or space vehicles. The techniques provided herein may be applied to, or otherwise provided for, use in various systems, such as, e.g., Global Positioning System (GPS), Galileo, Glonass, Compass, Quasi-Zenith Satellite System (QZSS) over Japan, Indian Regional Navigational Satellite System (IRNSS) over India, Beidou, etc., and/or various augmentation systems (e.g., a Satellite Based Augmentation System (SBAS)) that may be associated with or otherwise provided for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

Thus, the device 120 may communicate with any one or a combination of the SPS satellites (such as the satellite 102), WAN-WAPs (such as the WAN-WAP 104), and/or LAN-WAPs (such as the LAN-WAP 106). In some embodiments, each of the aforementioned systems can provide an independent information estimate of the position for the device 120 using different techniques. In some embodiments, the mobile device may combine the solutions derived from each of the different types of access points to improve the accuracy of the position data. Location information obtained from RF transmissions may supplement or used independently of location information derived, for example, based on data determined from decoding light-based communications provided by light fixtures such as the light fixture 130 (through emissions from the light source 136). In some implementations, a coarse location of the device 120 may be determined using RF-based measurements, and a more precise position may then be determined based on decoding of light-based messaging. For example, a wireless communication network may be used to determine that a device (i.e. an automobile-mounted device, a smartphone, etc.) is located in a general area (i.e., determine a coarse location, such as the floor in a high-rise building). Subsequently, the device would receive light-based communications (such as VLC) from one or more light sources in that determined general area, decode such light-based communication using a light-capture device (e.g., camera) with a modified lens assembly (e.g., a lens assembly that includes partial-image-blurring features), and use the decoded communications (which may be indicative of a location of the light source(s) transmitting the communications) to pinpoint its position.

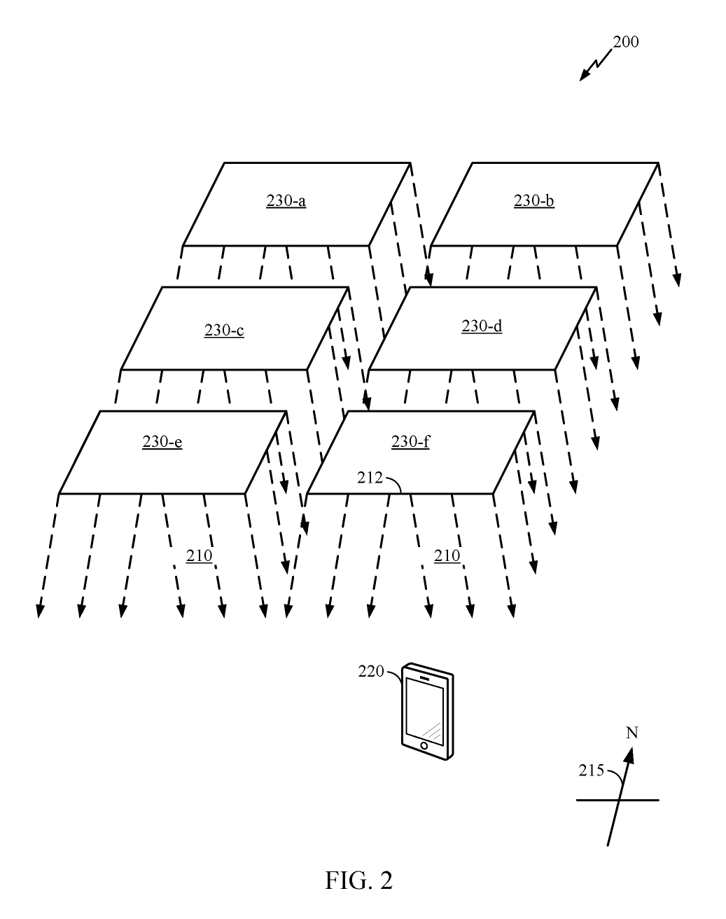

With reference now to FIG. 2, a diagram of an example light-based communication system 200 is shown. The system 200 includes a device 220 (which may be similar in configuration and/or functionality to the device 120 of FIG. 1, and may be a mobile device, a car-mounted camera, etc.) positioned near (e.g., below) a number of light fixtures 230-a, 230-b, 230-c, 230-d, 230-e, and 230-f. The light fixtures 230-a, 230-b, 230-c, 230-d, 230-e, and 230-f may, in some cases, be examples of aspects of the light fixture 130 described with reference to FIG. 1. The light fixtures 230-a, 230-b, 230-c, 230-d, 230-e, and 230-f may, in some examples, be overhead light fixtures in a building (or overhead street/area lighting out of doors), which may have fixed locations with respect to a reference (e.g., a global positioning system (GPS) coordinate system and/or building floor plan). In some embodiments, the light fixtures 230-a, 230-b, 230-c, 230-d, 230-e, and 230-f may also have fixed orientations with respect to a reference (e.g., a meridian passing through magnetic north 215).

As the device 220 moves (or is moved) under one or more of the light fixtures 230-a, 230-b, 230-c, 230-d, 230-e, and 230-f, a light-capture device of the device 220 (which may be similar to the light-capture device 140 of FIG. 1) may receive light 210 emitted by one or more of the light fixtures 230-a, 230-b, 230-c, 230-d, 230-e, and 230-f and capture an image of part or all of one or more of the light fixtures 230-a, 230-b, 230-c, 230-d, 230-e, and 230-f. The light-capture device of the device 220 may include one or more partial-image-blurring features to cause blurring of respective portions of each of the captured images to facilitate decoding of coded data included with light-based communications emitted by any of the light fixtures of the system 200. The captured image(s) may include an illuminated reference axis, such as the illuminated edge 212 of the light fixture 230-f. Such illuminated edges may enable the mobile device to determine its location and/or orientation with reference to one or more of the light fixtures 230-a, 230-b, 230-c, 230-d, 230-e, and 230-f. Alternatively or additionally, the device 220 may receive, from one or more of the light fixtures 230-a, 230-b, 230-c, 230-d, 230-e, and 230-f, light-based communication (e.g., VLC signals) transmissions that include codewords (comprising symbols), such as identifiers, of one or more of the light fixtures 230-a, 230-b, 230-c, 230-d, 230-e, and/or 230-f. The received codewords may be used to generally determine a location of the device 220 with respect to the light fixtures 230-a, 230-b, 230-c, 230-d, 230-e, and 230-f, and/or to look up locations of one or more of the light fixtures 230-a, 230-b, 230-c, 230-d, 230-e, and 230-f and determine, for example, a location of the device 220 with respect to a coordinate system and/or building floor plan. Additionally or alternatively, the device 220 may use the locations of one or more of the light fixtures 230-a, 230-b, 230-c, 230-d, 230-e, and 230-f, along with captured images (and known or measured dimensions and/or captured images of features, such as corners or edges) of the light fixtures 230-a, 230-b, 230-c, 230-d, 230-e, and 230-f, to determine a more precise location and/or orientation of the device 220. Upon determining the location and/or orientation of the device 220, the location and/or orientation may be used for navigation by the device 220.

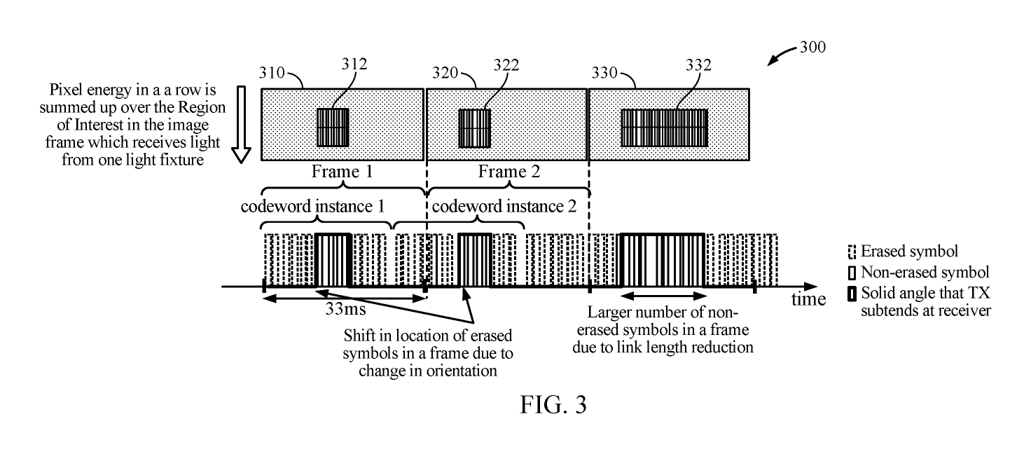

As noted, a receiving device (e.g., a mobile phone, such as the device 120 of FIG. 1, or some other device) uses its light-capture device, which is equipped with a gradual-exposure module/circuit (e.g., a rolling shutter) and/or one or more partial-image-blurring features, to capture a portion of, or all of, a transmission frame of the light source (during which part of, or all of, a codeword the light source is configured to communicate is transmitted). A light-capture device employing a rolling shutter, or another type of gradual-exposure mechanism, captures an image (or part of an image) over some predetermined time interval such that different rows in the frame are captured at different times, with the time associated with the first row of the image and the time associated with the last row of the image defining a frame period. In embodiments in which the mobile device is not stationary, the portion of a captured image corresponding to the light emitted from the light source will vary. For example, with reference to FIG. 3, a diagram 300 illustrating captured images, over three separate frames, of a scene that includes a light source emitting a light-based communication (e.g., a VLC signal), is shown. Because the receiving device's spatial relationship relative to the light source varies over the three frames (e.g., because the device's distance to the light source is changing, and/or because the device's orientation relative to the light source is changing, etc.), the region of interest in each captured image will also vary. In the example of FIG. 3, variation in the size and position of the region of interest in each of the illustrated captured frames may be due to a change in the orientation of the receiving device's light-capture device relative to the light source (the light source is generally stationary). Thus, for example, in a first captured frame 310 the light-capture device of the receiving device is at a first orientation (e.g., angle and distance) relative to the light source so that the light-capture device can capture a region of interest, corresponding to the light source, with first dimensions 312 (e.g., size and/or position). At a subsequent time interval, corresponding to a second transmission frame for the light source (during which the same codeword may be communicated), the receiving device has changed its orientation relative to the light source, and, consequently, the receiving device's light-capture device captures a second image frame 320 in which the region of interest corresponding to the light source has second dimensions 322 (e.g., size and/or a position) different from the first dimensions of the region of interest in the first frame 310. During a third time interval, in which the receiving device may again have changed its orientation relative to the light source, a third image frame 330, that includes a region of interest corresponding to the light source, is captured, with the region of interest including third dimensions 332 that are different (e.g., due to the change in orientation of the receiving device and its light-capture device relative to the light source) from the second dimensions.

Thus, as can be seem from the illustrated regions of interest in each of the captured frames 310, 320, and 330 of FIG. 3, the distance and orientation of the mobile image sensor relative to the transmitter (the light source) impacts the number and positions of symbol erasures per frame. At long range, it is possible that all but a single symbol per frame is erased (even the one symbol observed may have been partially erased). To mitigate the changing dimensions of the regions of interest of captured images, the implementations described herein cause at least parts of the images (e.g., the parts corresponding to the light sources) to be blurred/defocused in order to increase the number of symbols (in a coded messages of the light-based communication emitted by the light sources appearing in the captured images) that appear in the captured images.

With reference now to FIG. 4, a block diagram of an example device 400 (e.g., a mobile device, such as a cellular phone, a car-mounted device with a camera, etc.) configured to capture an image(s) of a light source transmitting a light-based communication (e.g., a communication comprising VLC signals) corresponding to, for example, an assigned codeword, and to determine from the captured image the assigned codeword, is shown. The device 400 may be similar in implementation and/or functionality to the devices 120 or 220 of FIGS. 1 and 2. For the sake of simplicity, the various features/components/functions illustrated in the schematic boxes of FIG. 4 are connected together using a common bus 410 to represent that these various features/components/functions are operatively coupled together. Other connections, mechanisms, features, functions, or the like, may be provided and adapted as necessary to operatively couple and configure a portable wireless device. Furthermore, one or more of the features or functions illustrated in the example of FIG. 4 may be further subdivided, or two or more of the features or functions illustrated in FIG. 4 may be combined. Additionally, one or more of the features, components, or functions illustrated in FIG. 4 may be excluded. In some embodiments, some or all of the components depicted in FIG. 4 may also be used in implementations of one or more of the light fixture 130 and/or the controller 110 depicted in FIG. 1, or may be used with any other device or node described herein.

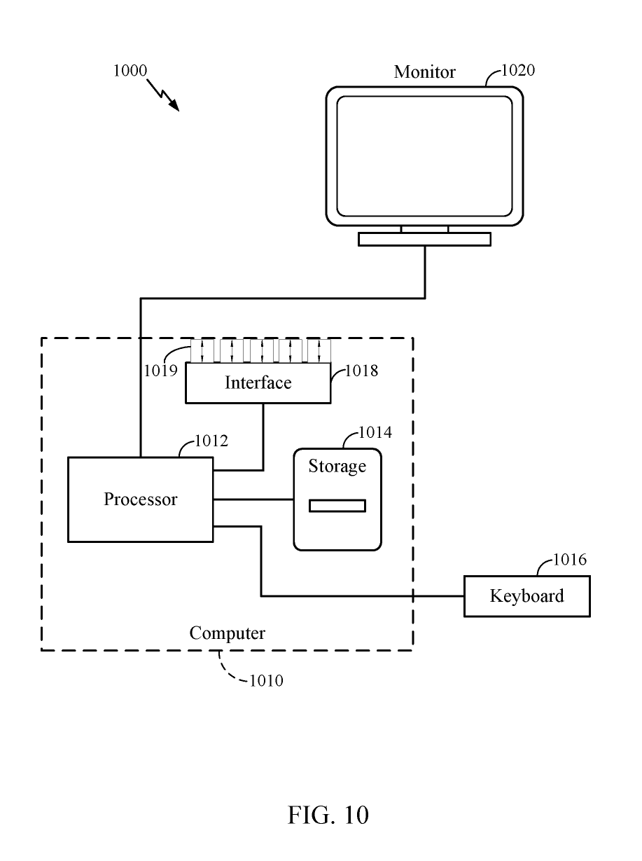

As noted, in some embodiments, the assigned codeword, encoded into repeating light-based communications transmitted by a light source (such as the light source 136 of the light fixture 130 of FIG. 1) may include, for example, an identifier codeword to identify the light fixture (the light source may be associated with location information, and thus, identifying the light source may facilitate position determination for the receiving device) or may include other types of information (which may be encoded using other types of encoding schemes). As shown, in some implementations, the device 400 may include receiver modules, a controller/processor module 420 to execute application modules (e.g., software-implemented modules stored in a memory storage device 422), and/or transmitter modules. Each of these components may be in communication (e.g., electrical communication) with each other. The components/units/modules of the device 400 may, individually or collectively, be implemented using one or more application-specific integrated circuits (ASICs) adapted to perform some or all of the applicable functions in hardware. Alternatively and/or additionally, functions of the device 400 may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs). The functions of each unit may also be implemented, in whole or in part, with instructions embodied in a memory, formatted to be executed by one or more general or application-specific processors. The device 400 may have any of various configurations, and may in some cases be, or include, a cellular device (e.g., a smartphone), a computer (e.g., a tablet computer), a wearable device (e.g., a watch or electronic glasses), a module or assembly associated with a vehicle or robotic machine (e.g., a module or assembly associated with a forklift, a vacuum cleaner, a car, etc.), and so on. In some embodiments, the device 400 may have an internal power supply (not shown), such as a small battery, to facilitate mobile operation. Further details about an example implementation of a processor-based device which may be used to realize, at least in part, the device 400, is provided below with respect to FIG. 10.

As further shown in FIG. 4, the receiver modules may include a light-based communication receiver module 412, which may be a light-capture device similar to the light-capture device 140 of FIG. 1, configured to receive a light-based communication such as a VLC signal (e.g., from a light source such as the light source 136 of FIG. 1, or from the light sources of any of the light fixtures 230-a-f depicted in FIG. 2). In some implementations, the light-capture device 412 may include one or more partial-image-blurring features included in a lens of the light-capture device (e.g., stripes made from some translucent material, or one or more scratches engraved into the lens). In some embodiments, the lens of the light-capture device (more than one lens may be included in some light-capture devices) may be a fixed-focus lens (e.g., for use with cameras installed in vehicles to facilitate driving and/or to implement vehicle safety systems), while in some embodiments, the lens may be a variable focus lens. In embodiments where a variable-focus lens is used, the entirety of a captured image of a scene may be blurred/defocused, thus causing the all the features in the scene, including light sources emitting coded light-based communications, to be blurred in order to facilitate decoding of the coded communications emitted by the light source. In such embodiments, partial-image-blurring features may or may not be additionally included with the lens. The light-based communication receiver module 412 may also include a photo detector (PD) or array of PDs, e.g., a complementary metal-oxide-semiconductor (CMOS) image sensor (e.g., camera), a charge couple device, or some other sensor-based camera. The light-based communication receiver module 412 may be implemented as a gradual-exposure light-capture device, e.g., a rolling shutter image sensor. In such embodiments, the image sensor captures an image over some predetermined time interval such that different rows in the frame are captured at different times. The light-based communication receiver module 412 may be used to receive, for example, one or more VLC signals in which one or more identifiers, or other information, are encoded. An image captured by the light-based communication receiver module 412 may be stored in a buffer such as an image buffer 462 which may be a part of the memory 422 schematically illustrated in FIG. 4. In some embodiments, two or more light-based communication receiver modules 412 could be used, either in concert or separately, to reduce the number of erased symbols and/or to improve light-based communication functionality from a variety of orientations, for example, by using both front and back mounted light-capture devices on a mobile device such as any of the devices 120, 220, and/or 500 described herein.

Additional receiver modules/circuits that may be used instead of, or in addition to, the light-based communication receiver module 412 may include one or more radio frequency (RF) receiver modules/circuits/controllers that are connected to one or more antennas 440. For example, the device 400 may include a wireless local area network (WLAN) receiver module 414 configured to enable, for example, communication according to IEEE 802.11x (e.g., a Wi-Fi receiver). In some embodiments, the WLAN receiver 414 may be configured to communicate with other types of local area networks, personal area networks (e.g., Bluetooth® wireless technology networks), etc. Other types of wireless networking technologies may also be used including, for example, Ultra Wide Band, ZigBee, wireless USB, etc. In some embodiments, the device 400 may also include a wireless wide area network (WWAN) receiver module 416 comprising suitable devices, hardware, and/or software for communicating with and/or detecting signals from one or more of, for example, WWAN access points and/or directly with other wireless devices within a network. In some implementations, the WWAN receiver may comprise a CDMA communication system suitable for communicating with a CDMA network of wireless base stations. In some implementations, the WWAN receiver module 416 may enable communication with other types of cellular telephony networks, such as, for example, TDMA, GSM, WCDMA, LTE, etc. Additionally, any other type of wireless networking technologies may be used, including, for example, WiMax (802.16), etc. In some embodiments, an SPS receiver 418 (also referred to as a global navigation satellite system (GNSS) receiver) may also be included with the device 400. The SPS receiver 418, as well as the WLAN receiver module 414 and the WWAN receiver module 416, may be connected to the one or more antennas 440 for receiving RF signals. The SPS receiver 418 may comprise any suitable hardware and/or software for receiving and processing SPS signals. The SPS receiver 418 may request information as appropriate from other systems, and may perform computations necessary to determine the position of the mobile device 400 using, in part, measurements obtained through any suitable SPS procedure.

In some embodiments, the device 400 may also include one or more sensors 430 such as an accelerometer, a gyroscope, a geomagnetic (magnetometer) sensor (e.g., a compass), any of which may be implemented based on micro-electro-mechanical-system (MEMS), or based on some other technology. Directional sensors such as accelerometers and/or magnetometers may, in some embodiments, be used to determine the device orientation relative to a light fixture(s), or used to select between multiple light-capture devices (e.g., light-based communication receiver module 412). Other sensors that may be included with the device 400 may include an altimeter (e.g., a barometric pressure altimeter), a thermometer (e.g., a thermistor), an audio sensor (e.g., a microphone) and/or other sensors. The output of the sensors may be provided as part of the data based on which operations, such as location determination and/or navigation operations, may be performed.

In some examples, the device 400 may include one or more RF transmitter modules connected to the antennas 440, and may include one or more of, for example, a WLAN transmitter module 432 (e.g., a Wi-Fi transmitter module, a Bluetooth® wireless technology networks transmitter module, and/or a transmitter module to enable communication with any other type of local or near-field networking environment), a WWAN transmitter module 434 (e.g., a cellular transmitter module such as an LTE/LTE-A transmitter module), etc. The WLAN transmitter module 432 and/or the WWAN transmitter module 434 may be used to transmit, for example, various types of data and/or control signals (e.g., to the controller 110 connected to the light fixture 130 of FIG. 1) over one or more communication links of a wireless communication system. In some embodiments, the transmitter modules and receiver modules may be implemented as part of the same module (e.g., a transceiver module), while in some embodiments the transmitter modules and the receiver modules may each be implemented as dedicated independent modules.

The controller/processor module 420 is configured to manage various functions and operations related to light-based communication and/or RF communication, including decoding light-based communications, such as VLC signals. As shown, in some embodiments, the controller 420 may be in communication (e.g., directly or via the bus 410) with a memory device 422 which includes a codeword derivation module 450. As illustrated in FIG. 4, an image captured by the light-based communication receiver module 412 may be stored in an image buffer 462, and processing operations performed by the codeword derivation module 450 may be performed on the data of the captured image stored in the image buffer 462. In some embodiments, codeword derivation module 450 may be implemented as a hardware realization, a software realization (e.g., as processor-executable code stored on non-transitory storage medium such as volatile or non-volatile memory, which in FIG. 4 is depicted as the memory storage device 422), or as a hybrid hardware-software realization. The controller 420 may be implemented as a general processor-based realization, or as a customized processor realization, to execute the instructions stored on the memory storage device 422. In some embodiments, the controller 420 may be realized as an apps processor, a DSP processor, a modem processor, dedicated hardware logic, or any combination thereof. Where implemented, at least in part, based on software, each of the modules, depicted in FIG. 4 as being stored on the memory storage device 422, may be stored on a separate RAM memory module, a ROM memory module, an EEPROM memory module, a CD-ROM, a FLASH memory module, a Subscriber Identity Module (SIM) memory, or any other type of memory/storage device, implemented through any appropriate technology. The memory storage 422 may also be implemented directly in hardware.

In some embodiments, the controller/processor 420 may also include a location determination engine/module 460 to determine a location of the device 400 or a location of a device that transmitted a light-based communication (e.g., a location of a light source 136 and/or light fixture 130 depicted in FIG. 1) based, for example, on a codeword (identifier) encoded in a light-based communication transmitted by the light source. For example, in such embodiments, each of the codewords of a codebook may be associated with a corresponding location (provided through data records, which may be maintained at a remote server, or be downloaded to the device 400, associating codewords with locations). In some examples, the location determination module 460 may be used to determine the locations of a plurality of devices (light sources and/or their respective fixtures) that transmit light-based communications, and determine the location of the device 400 based at least in part on the determined locations of the plurality of devices. For example, a possible location(s) of the device may be derived as an intersection of visibility regions corresponding to points from which the light sources identified by the device 400 would be visible by the device 400. In some implementations, the location determination module 460 may derive the position of the device 400 using information derived from various other receivers and modules of the mobile device 400, e.g., based on receive signal strength indication (RSSI) and round trip time (RTT) measurements performed using, for example, the radio frequency receiver and transmitter modules of the device 400.

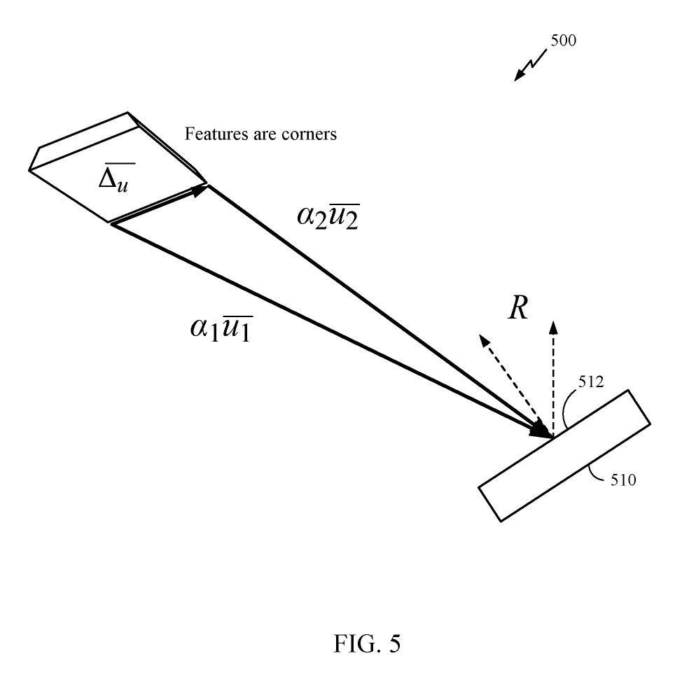

In some embodiments, physical features such as corners/edges of a light fixture (e.g., a light fixture identified based on the codeword decoded by the mobile device) may be used to achieve ‘cm’ level accuracy in determining the position of the mobile device. For example, and with reference to FIG. 5 showing a diagram of an example system 500 to determine position of a device 510 (e.g., a mobile device which may be similar to the devices 120, 220, or 400 of FIGS. 1, 2, and 4, respectively) that includes a light-capture device 512, consider a situation where an image is obtained from which two corners of a light fixture (e.g., a fixture transmitting a light-based communication identifying that fixture, with that fixture being associated with a known position) are visible and are detected. In this situation, the direction of arrival of light rays corresponding to each of the identified corners of the light fixture are represented as a unit vector u′₁ and u′₂ in the device's coordinate system. Based on measurements from the device's various sensors (e.g., measurements from an accelerometer, a gyroscope, a geomagnetic sensor, each of which may be similar to the sensors 430 of the device 400 of FIG. 4), the tilt of the mobile device may be derived/measured, and based on that the rotation matrix R of the device's coordinate system around that of the earth may be derived. The position and orientation of the device may then be derived based on the known locations of the two identified features (e.g., corner features of the identified fixture) by solving for the parameters α₁ and α₂ in the relationship:

α₁u′₁+α₂u′₂=R⁻¹Δ′ᵤ,

where Δ′ᵤ is the vector connecting the two known features.

In some examples, the device 400 and/or the controller/processor module 420 may include a navigation module (not shown) that uses a determined location of the device 400 (e.g., as determined based on the known locations of one or more light sources/fixtures transmitting the VLC signals) to implement navigation functionality.

As noted, a light-based communication (such as a VLC signal) transmitted from a particular light source, is received by the light-based communication receiver module 412, which may be an image sensor with a gradual-exposure mechanism (e.g., a CMOS image sensor with a rolling shutter) configured to capture on a single frame time-dependent image data representative of a scene (a scene that includes one or more light sources transmitting light-based communications, such as VLC signals) over some predetermined interval (e.g., the captured scene may correspond to image data captured over 1/30 second), such that different rows contain image data from the same scene but for different times during the pre-determined interval. As further noted, the captured image data may be stored in an image buffer which may be realized as a dedicated memory module of the light-based communication receiver module 412, or may be realized on the memory 422 of the device 400. A portion of the captured image will correspond to data representative of the light-based communication transmitted by the particular light source (e.g., the light source 136 of FIG. 1, with the light source comprising, for example, one or more LEDs) in the scene, with a size of that portion based on, for example, the distance and orientation of the light-based communication receiver module to the light source in the scene. In some situations, the part of the light-based communication may be captured at a low exposure setting of the light-based communication receiver module 412, so that high frequency pulses are not attenuated.

Having captured an image frame that includes time-dependent data from a scene including the particular light source (or multiple light sources), the codeword derivation module 450, for example, is configured to process the captured image frame to extract symbols encoded in the light-based communication occupying a portion of the captured image (as noted, the size of the portion will depend on the distance from the light source, and/or on the orientation of the light-based communication receiver module relative to the light source). The symbols extracted may represent at least a portion of the codeword (e.g., an identifier) encoded into the light-based communication, or may represent some other type of information. In some situations, the symbols extracted may include sequential (e.g., consecutive) symbols of the codeword, while in some situations the sequences of symbols may include at least two non-consecutive sub-sequences of the symbols from a single instance of the codeword, or may include symbol sub-sequences from two transmission frames (which may or may not be adjacent frames) of the light source (i.e., from separate instances of a repeating light-based communication).

As also illustrated in FIG. 4, the device 400 may further include a user interface 470 providing suitable interface systems, such as a microphone/speaker 472, a keypad 474, and a display 476 that allows user interaction with the device 400. The microphone/speaker 472 provides for voice communication services (e.g., using the wide area network and/or local area network receiver and transmitter modules). The keypad 474 may comprise suitable buttons for user input. The display 476 may include a suitable display, such as, for example, a backlit LCD display, and may further include a touch screen display for additional user input modes.

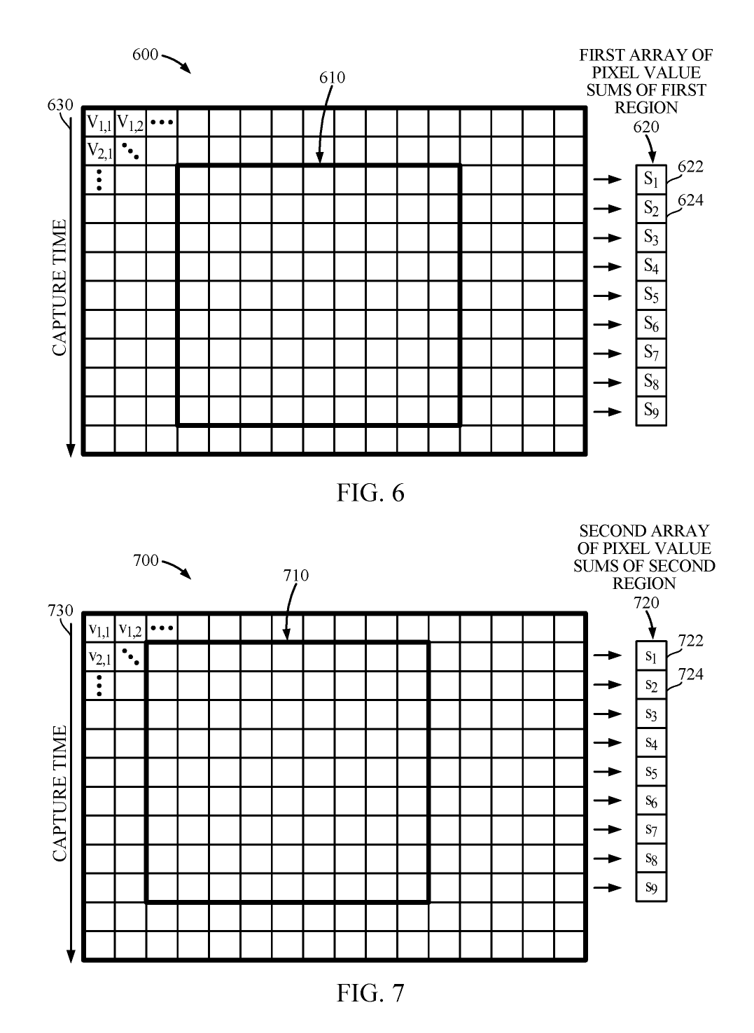

In some embodiments, decoding the symbols from a light-based communication may include determining pixel brightness values from a region of interest in at least one image (the region of interest being a portion of the image corresponding to the light source illumination), and/or determining timing information associated with the decoded symbols. Determination of pixel values, based on which symbols encoded into the light-based communication (e.g., VLC signal) can be identified/decoded, is described in relation to FIG. 6 showing a diagram of an example image 600, captured by an image sensor array (such as that found in the light-based communication receiver module 412), that includes a region of interest 610 corresponding to illumination from a light source. In the example illustration of FIG. 6, the image sensor captures an image using an image sensor array of 192 pixels which is represented by 12 rows and 16 columns. Other implementations may use any other image sensor array size (e.g., 307,200 pixels, represented by 480 rows and 640 columns), depending on the desired resolution and on cost considerations. As shown, the region of interest 610 in the example image 600 is visible during a first frame time. In some embodiments, the region of interest may be identified/detected using image processing techniques (e.g., edge detection processes) to identify areas in the captured image frame with particular characteristics, e.g., a rectangular area with rows of pixels of substantially uniform values. For the identified region of interest 610, an array 620 of pixel sum values is generated. Vertical axis 630 corresponds to capture time; and the rolling shutter implementation in the light-capture device results in different rows of pixels corresponding to different times. It is to be noted that in implementation in which partial-image-blurring features are provided with the light-capture device, the region-of-interest corresponding to scan lines caused by the partial-image-blurring features would generally be a couple of pixels wide.

Each pixel in the image 600 captured by the image sensor array includes a pixel value representing energy recovered corresponding to that pixel during exposure. For example, the pixel of row 1 and column 1 has pixel value V_{1,1}. As noted, the region of interest 610 is an identified region of the image 600 in which the light-based communication is visible during the first frame. In some embodiments, the region of interest is identified based on comparing individual pixel values, e.g., an individual pixel luma value, to a threshold and identifying pixels with values which exceed the threshold, e.g., in a contiguous rectangular region in the image sensor. In some embodiments, the threshold may be 50% the average luma value of the image 600. In some embodiments, the threshold may be dynamically adjusted, e.g., in response to a failure to identify a first region or a failure to successfully decode information being communicated by a light-based communication in the region 610.

The pixel sum values array 620 is populated with values corresponding to sum of pixel values in each row of the identified region of interest 610. Each element of the array 620 may correspond to a different row of the region of interest 610. For example, array element S₁ 622 represents the sum of pixel values (in the example image 600) of the first row of the region of interest 610 (which is the third row of the image 600), and thus includes the value that is the sum of V_{3,4}, V_{3,5}, V_{3,6}, V_{3,7}, V_{3,8}, V_{3,9}, V_{3,10}, V_{3,11}, and V_{3,12} (in some embodiments, a region-of-interest may be only several pixels wide, corresponding to a blurred portion appearing in an image). Similarly, the array element S₂ 624 represents the sum of pixel values of the second row of the region of interest 610 (which is row 4 of the image 600) of V_{4,4}, V_{4,5}, V_{4,6}, V_{4,7}, V_{4,8}, V_{4,9}, V_{4,10}, V_{4,11}, and V_{4,12}.

Array element 622 and array element 624 correspond to different sample times as the rolling shutter advances. The array 620 is used to recover a light-based communication (e.g., VLC signal) being communicated. In some embodiments, the VLC signal being communicated is a signal tone, e.g., one particular frequency in a set of predetermined alternative frequencies, during the first frame, and the single tone corresponds to a particular bit pattern in accordance with known predetermined tone-to-symbol mapping information.

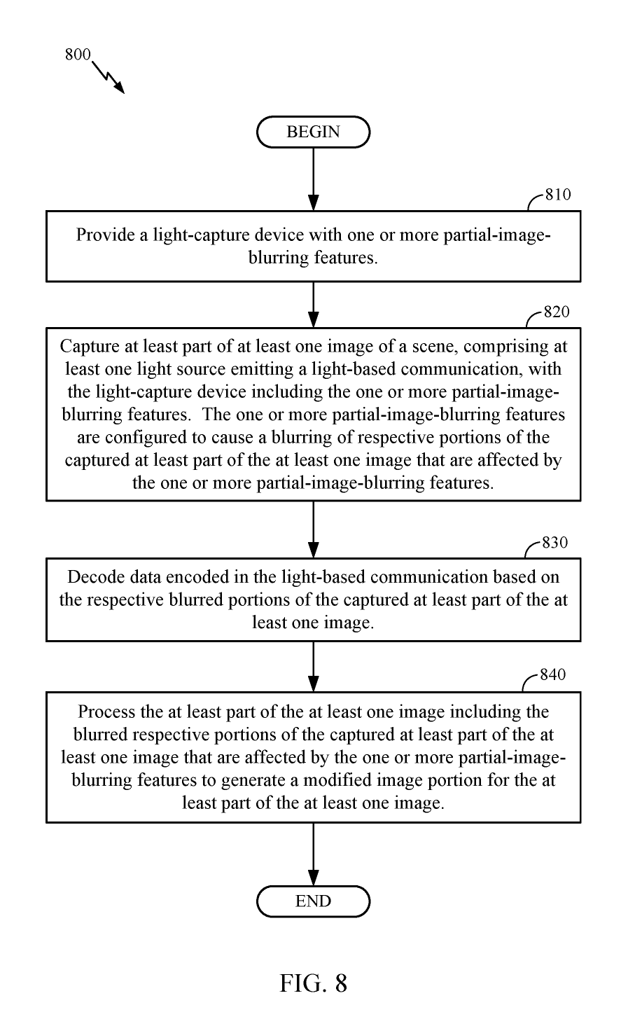

FIG. 7 is a diagram of another example image 700 captured by the same image sensor (which may be part of the light-based communication receiver module 412) that captured the image 600 of FIG. 6, but at a subsequent time interval to the time interval during which image 600 was captured by the image sensor array. The image 700 includes an identified region of interest 710 in which the light-based communication (e.g., VLC signal) is visible during the second frame time interval, and a corresponding generated array of pixel sum values 720 to sum the pixel values in the rows of the identified region of interest 710. As noted, in situations in which a light-capture device of a moving mobile device (such as a mobile phone) is used to capture the particular light source(s), the dimensions of the region of interests in each of the captured frames may vary as the mobile device changes its distance from the light source and/or changes its orientation relative to the light source. As can be seen in the example captured image 700 of FIG. 7, the region of interest 710 is closer to the top left corner of the image 700 than the region of interest 610 was to the top left corner of the image 600. The difference in the position of the identified regions of interest 610 and 710, respectively, with reference to the images 600 and 700, may have been the result of a change in the orientation of the mobile device from the time at which the image 600 was being captured and the time at which the image 700 was being captured (e.g., the mobile device, and thus its image sensor, may have moved a bit to the right and down, relative to the light source, thus causing the image of the light source to be closer to the top left corner of the image 700). In some embodiments, the size of first region of interest 610 may be different than the size of the second region of interest 710. In situations where the size of the region of interest decreases, the apparent size may be increased by either defocusing the entire captured image (to thus cause the features visible in the scene, including the light sources, to increase in size), or by partially defocusing or blurring, using one or more partial-image-blurring features included with a lens of the light-capture device, some portions of the image while keeping other portion substantially unaffected by the partial blurring.

In FIG. 7, a vertical axis 730 corresponds to capture time, and the rolling shutter implementation in the camera results in different rows of pixels corresponding to different times. Here too, the image 700 may have been captured by an image sensor that includes the array of 192 pixels (i.e., the array that was used to capture the image 600), which can be represented by 12 rows and 16 columns.

Each pixel in the image 700 captured by the image sensor array has a pixel value representing energy recovered corresponding to that pixel during exposure. For example, the pixel of row 1, column 1, has pixel value v_{1,1}. A region of interest block 710 is an identified region in which the VLC signal is visible during the second frame time interval. As with the image 600, in some embodiments, the region of interest may be identified based on comparing individual pixel values to a threshold, and identifying pixels with values which exceed the threshold, e.g., in a contiguous rectangular region in the captured image.

An array 720 of pixel value sums for the region of interest 710 of the image 700 is maintained. Each element of the array 720 corresponds to a different row of the region of interest 710. For example, array element s₁ 722 represents the sum of pixel values v_{2,3}, v_{2,4}, v_{2,5}, v_{2,6}, v_{2,7}, v_{2,8}, v_{2,9}, v_{2,10}, and v_{2,11}, while array element s₂ 724 represents the sum of pixel values v_{3,3}, v_{3,4}, v_{3,5}, v_{3,6}, v_{3,7}, v_{3,8}, v_{3,9}, v_{3,10}, and v_{3,11}. The array element 722 and the array element 724 correspond to different sample times as the rolling shutter (or some other gradual-exposure mechanism) advances.

Decoded symbols encoded into a light-based communication captured by the light-capture device (and appearing in the region of interest of the captured image) may be determined based, in some embodiments, on the computed values of the sum of pixel values (as provided by, for example, the arrays 620 and 720 shown in FIGS. 6 and 7 respectively). For example, the computed sum values of each row of the region of interest may be compared to some threshold value, and in response to a determination that the sum value exceeds the threshold value (or that the sum is within some range of values), the particular row may be deemed to correspond to part of a pulse of a symbol. In some embodiments, the pulse's timing information, e.g., its duration (which, in some embodiments, would be associated with one of the symbols, and thus can be used to decode/identify the symbols from the captured images) may also be determined and recorded. A determination that a particular pulse has ended may be made if there is a drop (e.g., exceeding some threshold) in the pixel sum value from one row to another. Additionally, in some embodiments, a pulse may be determined to have ended only if there are a certain number of consecutive rows (e.g., 2, 3 or more), following a row with a pixel sum that indicates the row is part of a pulse, that are below a non-pulse threshold (that threshold may be different from the threshold, or value range, used to determine that a row is part of a pulse). The number of consecutive rows required to determine that the current pulse has ended may be based on the size of the region of interest. For example, small regions of interest (in situations where the mobile device may be relatively far from the light source) may require fewer consecutive rows below the non-pulse threshold, than the number of rows required for a larger region of interest, in order to determine that the current pulse in the light-based communication signal has ended.

Having decoded one or more symbol sub-sequences for the particular codeword, the codeword derivation module 450 is applied to the one or more decoded symbols in order to determine/identify codewords. The decoding procedures implemented depend on the particular coding scheme used to encode data in the light-based communication. Examples of some coding/decoding procedures that may be implemented and used in conjunction with the systems, devices, methods, and other implementations described herein include, for example, the procedures described in U.S. application Ser. No. 14/832,259, entitled “Coherent Decoding of Visible Light Communication (VLC) Signals,” or U.S. application Ser. No. 14/339,170 entitled “Derivation of an Identifier Encoded in a Visible Light Communication Signal,” the contents of which are hereby incorporated by reference in their entireties. Various other coding/decoding implementations for light-based communications may also be used.

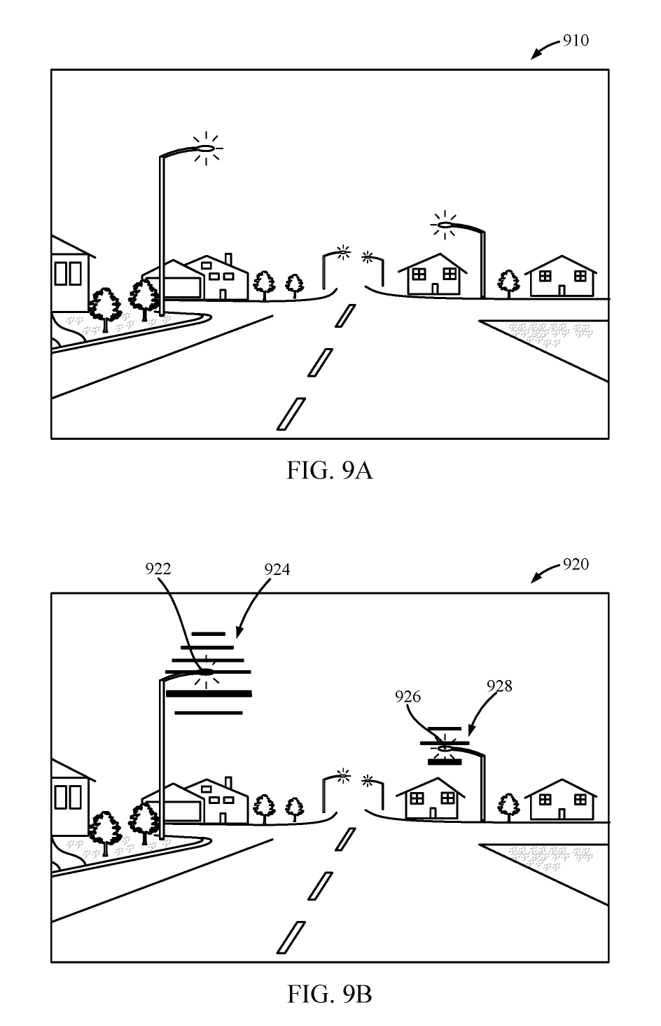

With reference now to FIG. 8, a flowchart of an example procedure 800 to process light-based communications is shown. The example procedure 800 includes providing, at block 810, a light-capture device (such as a CMOS image-sensor-based device, a charge couple device, or some other sensor-based camera) with one or more partial-image-blurring features. As discusses, in some implementations, the light-capture device may include a fixed-focus lens (e.g., used, for example, in car-mounted cameras), and the partial-image blurring features may include multiple stripes (realized, for example, as stripes of a translucent material coated, coupled, or otherwise disposed on the lens) that define an axis (or multiple axes) such as the axis defined by the stripes 144a-n depicted in FIG. 1. The axis so defined may be oriented in a direction substantially orthogonal to a scanning direction at which images are captured by the light-capture device (e.g., the scanning, relative to the sensor array of the light-capture device, may be performed on a row-by-row basis, with the stripes of the blurring materials placed on the lens being substantially parallel to one or more of the columns of the sensor array). The partial-image blurring features of the device may be realized, in some embodiments, by engraving scratches into a surface of the lens of light-capture device, which also may define an axis (or multiple axes) substantially orthogonal to the scanning direction at which images are captured. The partial-image blurring features are configured to cause blurring at respective portions of the captured at least part of the at least one image that are affected by the one or more partial-image-blurring features.

In some embodiments, the light-capture device may be a variable focus device, whose focus setting may be adjusted. In such embodiments, to facilitate decoding of the coded light-based communications, the focus setting of the light-capture device may be adjusted from a first setting (which may or may not capture a scene substantially in focus) to a second, defocused setting. The adjustment of the light-capture device's focus setting may be performed in response to a determination of poor decoding conditions when the focus setting are configured to the first focus setting.

As further shown in FIG. 8, the procedure 800 also includes capturing, at block 820, at least part of at least one image of a scene, with the scene including a light source (or multiple light sources) emitting the light-based communication(s). As discussed, in some embodiments, a moveable lens may be moved so that at least some of the partial-image blurring features may be substantially aligned with at least one of the light sources appearing in the scene being captured by the light-capture device (causing a more significant blurring of the light source image to increase its size, thus facilitating the decoding process). For example, the light-capture device may be able to detect potential points in a scene where light sources may be operating (e.g., based on detected luminosity level in a captured image), and causes a movement of the lens (e.g., through a motor and track mechanism) so that at least one of the partial-image-blurring features is aligned on the detected potential light source(s). In some embodiments, a user may cause an adjustment of the orientation of the mobile device (and, as a result, of the light-capture device) to position at least one of the partial-image blurring features close to, or directly on, at least one of the features appearing in a captured image that corresponds to a light source. In some embodiments, no adjustment of the position of the partial-image-blurring features (whether automatic or manual) is performed. In such embodiments, some residual blurring of the image portions corresponding to light sources may still be caused even if the partial-image blurring features do not exactly (or at all) overlap the image portions corresponding to one or more of the light sources. As noted, in such embodiments, the blurring averages light emanating from the light source(s) transmitting the modulated light-based communication, and the gradual-exposure mechanism (e.g., a rolling shutter) samples the averaged values in time. Even if the light source is not directly aligned with the blurred portion (e.g., a blurred stripe), the averaged intensity values fluctuate.

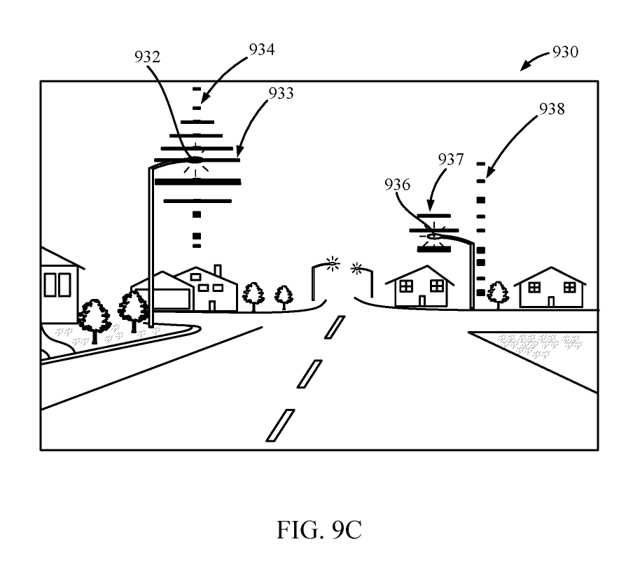

To illustrate the image capturing operations performed with partial-image capturing features, consider the various images shown in FIGS. 9A-C. FIG. 9A is an example image 910 of a street scene in which several light sources emitting modulated light (constituting a light-based communication of an identifier, or some other information) appear. The image of FIG. 9A is captured using a conventional digital camera without using a specifically implemented gradual-exposure mechanism (e.g., a rolling-shutter). FIG. 9B shows an example of an image 920 of the same street scene, but this time captured with a light-capture device that includes a gradual-exposure mechanism. As illustrated, the image 920 includes time-dependent scan lines 924 and 928 corresponding to the coded communication (implemented as VLC signals) emitted by light sources 922 and 926, respectively. The image portion of the closer light source 922 results in a larger number of scan lines (representing, in this example, a sequence of ‘1’s and ‘0’s) as compared to the scan lines 928 resulting from the farther away light source 926. It is to be noted that although the number of scan lines for the farther away light source is smaller than for the nearer light source, the width of scan lines is generally the same regardless of the distance of the light source to the light capturing device, e.g., a scan line for a ‘1’ symbol will generally have the same width in pixels (i.e., pixel rows) no matter how far away the light source, although there will be fewer such captured lines the farther the light source is from the light-capture device. Consequently, decoding of the coded message represented by the scan lines 924 from the light source 922 is easier (and more practical) than decoding of the coded message represented by the scan lines 928. In fact, in some embodiments, it may not be possible at all to decode the message transmitted through the light emitted by the light source 926 if too few sensor rows of the light-capture device are occupied by the light emitted by the light source 926 (it is to be noted that it may still be possible to decode the coded message emitted by the more distant light source 926, but whether such decoding is feasible may depend on such factors of the particular coding scheme used, how many repetitions of the coded messages the light-capture device can capture, etc.)

FIG. 9C shows a further example of an image 930 of the same street scene of FIGS. 9A and 9B, captured with a light-capture device that includes a gradual exposure mechanism and further includes a lens provides with partial-image-blurring features. In the example of FIG. 9C, the partial-image-blurring features may be vertical stripes scribed into the lens to spread the light from light-sources appearing in the image. The light spreading caused by these stripes increases the number of scan lines 938 (corresponding to a light source 936) representative of the coded message transmitted by the light source 936, thus improving the decoding process, and increasing the likelihood of having a sufficient number of scan lines to be able to decode the coded message transmitted by the light source 936. As shown, another one or more light-spreading (i.e., image blurring) stripes is also used to improve the decoding of the coded message represented by scan lines 934 (corresponding to a light source 932). As also shown, the resultant scan line 938 are not aligned with the light source 936 (or with the scan line 937 which may be similar to the scan lines 928 of FIG. 9B) due to the fact that the partial-image-blurring features producing the scan lines 938 are, in this example, not aligned with the light source 936. On the other hand, as depicted in FIG. 9C, in this example the partial-image-blurring features producing the scan lines 934 are more closely aligned (overlap) with the light source 932 and the scan line 933 (which are similar to the scan lines 924 produced by a gradual-exposure mechanism without the use of a partial-image-blurring features).

Turning back to FIG. 8, having captured the image(s) of the scene using a lens that includes one or more partial-image blurring features, resulting in blurring (and thus light spreading) of some features in the scene (e.g., of the light sources transmitting light-based communications), data encoded in the light-based communication is decoded at block 830 based on the respective blurred portions of the captured at least part of the at least one image. As noted, in some embodiments, the light-based communication may include a visual light communication (VLC) signal, and decoding the encoded data may include identifying from the captured at least part of the at least one image a time-domain signal representative of one or more symbols comprising a VLC codeword encoded in the VLC signal, and determining, at least in part, the VLC codeword from the time-domain signal identified from the captured at least part of the at least one image. The decoding procedure applied generally depends on the particular coding scheme used (including the coding symbols defined for the scheme, timing characteristics and formatting of the codes used, etc.) to encode data in the light-based communication.

As described herein, the intentional blurring of at least some portions of the captured image results in a visually degraded image that, while improving the decoding functionality achieved through the capturing of images via the mobile device, obscures other features of the image, and/or renders the image hard to view for users. Accordingly, in some embodiments, the procedures 800 includes processing, at block 840, the at least part of the at least one image including the blurred respective portions of the captured at least part of the at least one image that are affected by the one or more partial-image-blurring features to generate a modified image portion for the at least part of the at least one image. As noted, in some embodiments, processing the partially (or fully) blurred image may include performing filtering operations on the captured image(s) by implementing a filter function that is an inverse of a known or approximated function representative of the blurring effect caused by the partial-image-blurring features. The blurring function causes by the partial-image-blurring features may be derived based on the dimensions (including the known position of the features on the lens) and characteristics of the materials or scratches that are used to realize the partial-image-blurring features. The inverse filtering applied to the captured images (either to the portions affected by the partial-image-blurring features, or to the entirety of the image(s)) may yield a reconstructed/restored image in which the blurred portions are, partially or substantially entirely, de-blurred. The reconstructed image(s) can then be presented on a display device of the device that includes the light-capture device, or on a display device of some remote device.

As also discussed herein, in some embodiments the mobile device may also be configured to determine (possibly with the aid of a remote device) locations of various features appearing in captured image (such as the light sources emitting the light-based communications, etc.) For example, in embodiments in which the light-capture device used is a variable-focus device, focus setting of the light-capture device may be adjusted so that captured images of the scene are substantially in focus (with the possible exception of portions of the image that are affected by the one or more partial-image-blurring features of the light-capture device). Thus, in such embodiments, capturing the at least part of the at least one image of the scene includes capturing the at least part of the at least one image of the scene with the light-capture device including the one or more partial-image-blurring features such that the respective portions of the captured at least part of the at least one image that are affected by the one or more partial-image-blurring features are blurred and remainder portions of the captured at least part of the at least one image are substantially in focus. Locations of one or more objects appearing in the captured at least part of the at least one image of the scene (e.g., the location relative to the light-capture device, or the location in some local or global coordinate system) can then be determined based on the remainder portions of the captured at least part of the at least one image that are substantially in focus (e.g., according to a process similar to that described in relation to FIG. 5, or according to some other procedure to determine locations of objects appearing in an image).

In some implementations, a light-capture device may be configured to control the extent/level of blurring for an entire captured image. For example, the light-capture device may be a variable-focus device, and may thus be configured to have its focus setting adjusted to a second, defocused (or blurred), focus setting in response to a determination of poor decoding conditions with the focus setting adjusted to a first focus setting (a determination of poor decoding conditions may be made, for example, if a coded message emitted by a light source appearing in a captured image cannot be decoded within some predetermine period of time). In such embodiments, with the focus setting adjusted to the second focus setting, one or more images of a scene (which includes at least one light source emitting the light-based communication) are captured, data encoded in the light-based communication is decoded from the captured one or more images of the scene including the at least one light source. In some embodiments, the light source may be in-focus when the light-capture device is operating in the first focus setting, and may be out-of-focus when the light-capture device is in the second focus setting (however, in some situations, the first focus setting may correspond to setting in which the light source is out of focus, and the second focus setting may correspond to settings in which the light source is even further out of focus for the light-capture device). In some variations, adjusting the focus setting of the light-capture device may include adjusting a lens of the light-capture device, adjusting an aperture of the light-capture device, or both. In some embodiments, a position of the light source(s) (appearing in the scene) may be determine based, at least in part, on image data from the one or more focused image captured at a time during which the focus setting of the light-capture device is substantially in focus. In some embodiments, the light-capture device may have its focus setting adjusted so as to intermittently capture de-focused (blurred) images of the scene (containing at least one light source emitting coded messages) during a first at least one time interval, and to intermittently capture focused images of the scene (containing that at least one light source) during a second at least one time interval. In such embodiments, a position of the light source (e.g., within the image), or its absolute or relative position, may be determined based, at least in part, on image data from the one or more focused images captured during the second at least one time interval (e.g., to facilitate determination of the location of the at least one light source relative to the light-capture device, and thus to determine the location of the light-capture device).

Performing the procedures described herein may be facilitated by a processor-based computing system. With reference to FIG. 10, a schematic diagram of an example computing system 1000 is shown. Part or all of the computing system 1000 may be housed in, for example, a device (e.g., a mobile device, or a mounted device such as a car-mounted device) such as the devices 120, 220, and 400 of FIGS. 1, 2 and 4, respectively, or may comprise part or all of the servers, nodes, access points, or base stations described herein, including the light fixture 130, and/or the nodes 104 and 106, depicted in FIG. 1. The computing system 1000 includes a computing-based device 1010 such as a personal computer, a specialized computing device, a controller, and so forth, that typically includes a central processor unit 1012. In addition to the CPU 1012, the system includes main memory, cache memory and bus interface circuits (not shown). The computing-based device 1010 may include a mass storage device 1014, such as a hard drive and/or a flash drive associated with the computer system. The computing system 1000 may further include a keyboard, or keypad, 1016, and a monitor 1020, e.g., a CRT (cathode ray tube) or LCD (liquid crystal display) monitor, that may be placed where a user can access them (e.g., a mobile device's screen).

The computing-based device 1010 is configured to facilitate, for example, the implementation of one or more of the procedures/processes/techniques described herein (including the procedures to capture images of scene using partial-image-blurring features, decode light-based communications, process images to generate reconstructed images, etc.). The mass storage device 1014 may thus include a computer program product that when executed on the computing-based device 1010 causes the computing-based device to perform operations to facilitate the implementation of the procedures described herein. The computing-based device may further include peripheral devices to provide input/output functionality. Such peripheral devices may include, for example, a CD-ROM drive and/or flash drive, or a network connection, for downloading related content to the connected system. Such peripheral devices may also be used for downloading software containing computer instructions to enable general operation of the respective system/device. For example, as illustrated in FIG. 10, the computing-based device 1010 may include an interface 1018 with one or more interfacing circuits (e.g., a wireless port that include transceiver circuitry, a network port with circuitry to interface with one or more network device, etc.) to provide/implement communication with remote devices (e.g., so that a wireless device, such as the device 120 of FIG. 1, could communicate, via a port such as the port 1019, with a controller such as the controller 110 of FIG. 1, or with some other remote device). Alternatively and/or additionally, in some embodiments, special purpose logic circuitry, e.g., an FPGA (field programmable gate array), a DSP processor, or an ASIC (application-specific integrated circuit) may be used in the implementation of the computing system 1000. Other modules that may be included with the computing-based device 1010 are speakers, a sound card, a pointing device, e.g., a mouse or a trackball, by which the user can provide input to the computing system 1000. The computing-based device 1010 may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Memory may be implemented within the computing-based device 1010 or external to the device. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

As used herein, a mobile device or station (MS) refers to a device such as a cellular or other wireless communication device, a smartphone, tablet, personal communication system (PCS) device, personal navigation device (PND), Personal Information Manager (PIM), Personal

Digital Assistant (PDA), laptop or other suitable mobile device which is capable of receiving wireless communication and/or navigation signals, such as navigation positioning signals. The term “mobile station” (or “mobile device” or “wireless device”) is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, tablet devices, etc., which are capable of communication with a server, such as via the Internet, WiFi, or other network, and to communicate with one or more types of nodes, regardless of whether satellite signal reception, assistance data reception, and/or position-related processing occurs at the device, at a server, or at another device or node associated with the network. Any operable combination of the above are also considered a “mobile station.” A mobile device may also be referred to as a mobile terminal, a terminal, a user equipment (UE), a device, a Secure User Plane Location Enabled Terminal (SET), a target device, a target, or by some other name.

While some of the techniques, processes, and/or implementations presented herein may comply with all or part of one or more standards, such techniques, processes, and/or implementations may not, in some embodiments, comply with part or all of such one or more standards.

The detailed description set forth above in connection with the appended drawings is provided to enable a person skilled in the art to make or use the disclosure. It is contemplated that various substitutions, alterations, and modifications may be made without departing from the spirit and scope of the disclosure. Throughout this disclosure the term “example” indicates an example or instance and does not imply or require any preference for the noted example. The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments. Thus, the disclosure is not to be limited to the examples and designs described herein but is to be accorded the widest scope consistent with the principles and novel features disclosed herein.

Although particular embodiments have been disclosed herein in detail, this has been done by way of example for purposes of illustration only, and is not intended to be limiting with respect to the scope of the appended claims, which follow. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A method to process a light-based communication, the method comprising:
providing a light-capture device with one or more partial-image-blurring features;
capturing at least part of at least one image of a scene, comprising at least one light source emitting the light-based communication, with the light-capture device including the one or more partial-image-blurring features, wherein the one or more partial-image-blurring features are configured to cause a blurring of respective portions of the captured at least part of the at least one image that are affected by the one or more partial-image-blurring features;
decoding data encoded in the light-based communication based on the respective blurred portions of the captured at least part of the at least one image; and
processing the at least part of the at least one image including the blurred respective portions of the captured at least part of the at least one image that are affected by the one or more partial-image-blurring features to generate a modified image portion for the at least part of the at least one image.

2. The method of claim 1, further comprising:
presenting the generated modified image portion for the at least part of the at least one image on a display device.

3. The method of claim 1, wherein the light-capture device with the one or more partial-image-blurring features is configured with fixed-length focus setting.

4. The method of claim 1, wherein providing the light-capture device with the one or more partial-image-blurring features comprises:
providing a lens of the light-capture device with the one or more partial image-blurring features.

5. The method of claim 4, wherein providing the lens with the one or more partial-image-blurring features comprises:
providing the lens with multiple stripes defining an axis oriented substantially orthogonal to a scanning direction at which images are captured by the light-capture device.

6. The method of claim 4, wherein providing the lens with the one or more partial-image-blurring features comprises:
coupling stripe-shaped structures onto the lens.

7. The method of claim 4, wherein providing the lens with the one or more partial-image-blurring features comprises:
forming stripe-shaped scratches in the lens.

8. The method of claim 1, wherein the light-based communication comprises a visual light communication (VLC) signal, and wherein decoding the data comprises:
identifying from the captured at least part of the at least one image a time-domain signal representative of one or more symbols comprising a VLC codeword encoded in the VLC signal; and
determining, at least in part, the VLC codeword from the time-domain signal identified from the captured at least part of the at least one image.

9. The method of claim 1, wherein the light-capture device comprises a digital camera with a gradual-exposure mechanism.

10. The method of claim 9, wherein the digital camera with the gradual-exposure mechanism comprises a CMOS camera including a rolling shutter.

11. The method of claim 1, further comprising:
adjusting focus setting of the light-capture device so that captured images of the scene are substantially in focus;
wherein capturing the at least part of the at least one image of the scene comprises capturing the at least part of the at least one image of the scene with the light-capture device including the one or more partial-image-blurring features such that the respective portions of the captured at least part of the at least one image that are affected by the one or more partial-image-blurring features are blurred and remainder portions of the captured at least part of the at least one image are substantially in focus.

12. The method of claim 11, further comprising:
determining locations of one or more objects appearing in the captured at least part of the at least one image of the scene based on the remainder portions of the captured at least part of the at least one image that are substantially in focus.

13. A mobile device comprising:
a light-capture device, including one or more partial-image-blurring features, to capture at least part of at least one image of a scene, the scene comprising at least one light source emitting a light-based communication, wherein the one or more partial-image-blurring features are configured to cause a blurring of respective portions of the captured at least part of the at least one image that are affected by the one or more partial-image-blurring features
memory configured to store the captured at least part of the at least one image; and
one or more processors coupled to the memory and the light-capture device, and configured to:
decode data encoded in the light-based communication based on the respective blurred portions of the captured at least part of the at least one image; and
process the at least part of the at least one image including the blurred respective portions of the captured at least part of the at least one image that are affected by the one or more partial-image-blurring features to generate a modified image portion for the at least part of the at least one image.

14. The mobile device of claim 13, further comprising:
a display device;
wherein the one or more processors are further configured to present the generated modified image portion for the at least part of the at least one image on the display device.

15. The mobile device of claim 13, wherein the light-capture device including the one or more partial-image-blurring features comprises:
a lens with the one or more partial image-blurring features.

16. The mobile device of claim 15, wherein the one or more partial-image-blurring features comprise: multiple stripes included with the lens and defining an axis oriented substantially orthogonal to a scanning direction at which images are captured by the light-capture device, stripe-shaped structures coupled onto the lens, stripe-shaped scratches formed in the lens, or any combination thereof.

17. The mobile device of claim 13, wherein the light-based communication comprises a visual light communication (VLC) signal, and wherein the one or more processors configured to decode the data are configured to:
identify from the captured at least part of the at least one image a time-domain signal representative of one or more symbols comprising a VLC codeword encoded in the VLC signal; and
determine, at least in part, the VLC codeword from the time-domain signal identified from the captured at least part of the at least one image.

18. The mobile device of claim 13, wherein the light-capture device comprises a digital camera with a gradual-exposure mechanism.

19. The mobile device of claim 18, wherein the digital camera with the gradual-exposure mechanism comprises a CMOS camera including a rolling shutter.

20. The mobile device of claim 13, wherein the one or more processors are further configured to:
adjust focus setting of the light-capture device so that captured images of the scene are substantially in focus;
and wherein the light-capture device configured to capture the at least part of the at least one image of the scene is configured to:
capture the at least part of the at least one image of the scene with the light-capture device including the one or more partial-image-blurring features such that the respective portions of the captured at least part of the at least one image that are affected by the one or more partial-image-blurring features are blurred and remainder portions of the captured at least part of the at least one image are substantially in focus.

21. An apparatus comprising:
means for capturing at least part of at least one image of a scene, comprising at least one light source emitting a light-based communication, with a light-capture device including one or more partial-image-blurring features, wherein the one or more partial-image-blurring features are configured to cause a blurring of respective portions of the captured at least part of the at least one image that are affected by the one or more partial-image-blurring features;
means for decoding data encoded in the light-based communication based on the respective blurred portions of the captured at least part of the at least one image; and
means for processing the at least part of the at least one image including the blurred respective portions of the captured at least part of the at least one image that are affected by the one or more partial-image-blurring features to generate a modified image portion for the at least part of the at least one image.

22. The apparatus of claim 21, wherein the light-capture device including the one or more partial-image-blurring features comprises:
a lens with the one or more partial image-blurring features.

23. The apparatus of claim 22, wherein the one or more partial-image-blurring features comprise: multiple stripes included with the lens and defining an axis oriented substantially orthogonal to a scanning direction at which images are captured by the means for capturing, stripe-shaped structures coupled onto the lens, stripe-shaped scratches formed in the lens, or any combination thereof.

24. The apparatus of claim 21, wherein the light-based communication comprises a visual light communication (VLC) signal, and wherein the means for decoding comprises:
means for identifying from the captured at least part of the at least one image a time-domain signal representative of one or more symbols comprising a VLC codeword encoded in the VLC signal; and
means for determining, at least in part, the VLC codeword from the time-domain signal identified from the captured at least part of the at least one image.

25. The apparatus of claim 21, wherein the light-capture device comprises a digital camera with a gradual-exposure mechanism.

26. A non-transitory computer readable media programmed with instructions, executable on a processor, to:
capture at least part of at least one image of a scene, comprising at least one light source emitting a light-based communication, with a light-capture device including one or more partial-image-blurring features, wherein the one or more partial-image-blurring features are configured to cause a blurring of respective portions of the captured at least part of the at least one image that are affected by the one or more partial-image-blurring features;
decode data encoded in the light-based communication based on the respective blurred portions of the captured at least part of the at least one image; and
process the at least part of the at least one image including the blurred respective portions of the captured at least part of the at least one image that are affected by the one or more partial-image-blurring features to generate a modified image portion for the at least part of the at least one image.

27. The computer readable media of claim 26, wherein the light-capture device including the one or more partial-image-blurring features comprises:
a lens with the one or more partial image-blurring features.

28. The computer readable media of claim 27, wherein the one or more partial-image-blurring features comprise: multiple stripes included with the lens and defining an axis oriented substantially orthogonal to a scanning direction at which images are captured by the light-capture device, stripe-shaped structures coupled onto the lens, stripe-shaped scratches formed in the lens, or any combination thereof.

29. The computer readable media of claim 26, wherein the light-based communication comprises a visual light communication (VLC) signal, and wherein the instructions to decode the data comprise one or more instructions to:
identify from the captured at least part of the at least one image a time-domain signal representative of one or more symbols comprising a VLC codeword encoded in the VLC signal; and
determine, at least in part, the VLC codeword from the time-domain signal identified from the captured at least part of the at least one image.

30. The computer readable media of claim 26, wherein the light-capture device comprises a digital camera with a gradual-exposure mechanism.
